(19) United States
(12) Patent Application Publication
(10) Pub. No.: US 2025/0131680 A1
(43) Pub. Date: Apr. 24, 2025

(54) FEATURE EXTRACTION WITH THREE-DIMENSIONAL INFORMATION

(71) Applicant: NVIDIA Corporation, Santa Clara, CA (US)

(72) Inventors: Or Litany, Sunnyvale, CA (US); Sanja Fidler, Toronto (CA); Huan Ling, Toronto (CA); Chenfeng Xu, Emeryville, CA (US)

(73) Assignee: NVIDIA Corporation, Santa Clara, CA (US)

(21) Appl. No.: 18/802,288

(22) Filed: Aug. 13, 2024

Related U.S. Application Data
(60) Provisional application No. 63/544,947, filed on Oct. 20, 2023.

(51) Int. Cl. G06V 10/25; G06T 3/18; G06T 7/70; G06T 11/00; G06V 20/70

(52) U.S. Cl. CPC G06V 10/25; G06T 3/18; G06T 7/70; G06T 11/00; G06V 20/70

(57) ABSTRACT

Disclosed are systems and methods relating to extracting 3D features, such as bounding boxes. The systems can apply, to one or more features of a source image that depicts a scene using a first set of camera parameters, based on a condition view image associated with the source image, an epipolar geometric warping to determine a second set of camera parameters. The systems can generate, using a neural network, a synthetic image representing the one or more features and corresponding to the second set of camera parameters.

### CROSS-REFERENCE TO RELATED APPLICATIONS

The present application claims the benefit of and priority to U.S. Provisional Application No. 63/544,947, filed Oct. 20, 2023, the disclosure of which is incorporated herein by reference in its entirety.

### BACKGROUND

Machine learning models, such as neural networks, can be used to represent environments or scenes. For example, image and/or video data of some portions of the environments can be used to extract a feature of an object therein. However, since images are two-dimensional (2D), objects (and by extension, their features) are also similarly depicted in the images in 2D. Accordingly, it can be difficult to extract three-dimensional (3D) features efficiently and accurately without significant computational resources. This is an issue when generating (e.g., synthetically) other depictions of the same objects, where additional dimensionality is critical for generating realistic depictions of objects with the appropriate proportions, effect on other objects in the scene, and general appearance.

### SUMMARY

Embodiments of the present disclosure relate to extracting 3D features. In contrast to conventional systems, such as those described above, systems and methods in accordance with the present disclosure can allow for 3D information—such as bounding boxes—of features within a source image to be extracted more efficiently and accurately. For example, systems and methods in accordance with the present disclosure can extract 3D information from a source image by utilizing a second and/or third neural network that can extract features from the source image.

At least one aspect relates to one or more processors. The one or more processors includes one or more circuits. The one or more circuits can apply, to one or more features of a source image that depicts a scene using a first set of camera parameters, based on a condition view image associated with the source image, an epipolar geometric warping to determine a second set of camera parameters, and generate, using a neural network, a synthetic image representing the one or more features and corresponding to the second set of camera parameters.

In some implementations, the neural network is updated using image pairs, at least one image pair depicting at least one feature of one or more objects in common and including data indicating a relative pose or position of a camera capturing each image of the at least one image pair. In some implementations, to apply the epipolar geometric warping, the one or more circuits are further to sample the one or more features along an epipolar line corresponding to the source image and the condition view image, and aggregate the one or more features at corresponding positions in the synthetic image. In some implementations, the one or more circuits are further to aggregate the one or more features using a differentiable aggregator. In some implementations, the neural network can include a stable diffusion model. In some implementations, representations of the one or more features in at least one layer of the neural network are unmodified by the epipolar geometry warping.

In some implementations, the one or more circuits are further to compute a first set of two-dimensional (2D) bounding boxes corresponding to at least one feature of the one or more features of the source image, compute a second set of 2D bounding boxes corresponding to the at least one feature in the synthetic image, and compute a set of three-dimensional (3D) bounding boxes corresponding to the at least one feature using the first and second sets of 2D bounding boxes. In some implementations, the one or more circuits are further to automatically assign a label corresponding to at least one 2D bounding box corresponding to the at least one feature of the one or more features of the source image to at least one 3D bounding box corresponding to the at least one feature.

In some implementations, the one or more circuits are further to provide the source image, the synthetic image, the first set of camera parameters, and the second set of camera parameters to a second neural network. The one or more circuits are further to update one or more parameters of the second neural network based at least on one or more of the source image, the synthetic image, the first set of camera parameters, or the second set of camera parameters. The one or more circuits are further to compute one or more 3D bounding boxes corresponding to one or more features of one or more input images using the second neural network. In some implementations, the one or more circuits are further to provide 2D bounding boxes and 3D bounding boxes corresponding to one or more features of the source image and one or more corresponding features of the synthetic image to update the one or more parameters of the second neural network.

At least one aspect relates to a system. The system includes one or more processors including one or more processing units. The one or more processing units can apply, to one or more features of a source image that depicts a scene using a first set of camera parameters, based on a condition view image associated with the source image, an epipolar geometric warping to determine a second set of camera parameters, and generate, using a neural network, a synthetic image representing the one or more features and corresponding to the second set of camera parameters.

In some implementations, the neural network is updated using image pairs, at least one image pair depicting at least one feature of one or more objects in common and including data indicating a relative pose or position of a camera capturing each image of the at least one image pair. In some implementations, to apply the epipolar geometric warping, the one or more processing units are further to sample the one or more features along an epipolar line corresponding to the source image and the condition view image, and aggregate the one or more features at corresponding positions in the synthetic image.

In some implementations, the one or more processing units are further to aggregate the one or more features using a differentiable aggregator. In some implementations, the neural network includes a stable diffusion model. In some implementations, representations of the one or more features in at least one layer of the neural network are unmodified by the epipolar geometry warping. In some implementations, the one or more processing units are further to compute a first set of two-dimensional (2D) bounding boxes corresponding to at least one feature of the one or more features of the source image, compute a second set of 2D bounding boxes corresponding to the at least one feature in the synthetic image, and compute a set of three-dimensional (3D) bounding boxes corresponding to the at least one feature using the first and second sets of 2D bounding boxes.

At least one aspect relates to a method. The method includes applying, by one or more processors, to one or more features of a source image that depicts a scene using a first set of camera parameters, based on a condition view image associated with the source image, a warping operation to determine a second set of camera parameters. The method includes generating, by the one or more processors, using a neural network, a synthetic image representing the one or more features and corresponding to the second set of camera parameters. In some implementations, the applying of the warping operation includes aligning the source image with the condition view image based on a comparison between the first set of camera parameters and the second set of camera parameters.

The one or more processors, systems, and/or methods described herein can be implemented by or included in at least one of a system for generating synthetic data, a system for performing simulation operations, a system for performing conversational AI operations, a system for performing collaborative content creation for 3D assets, a system performing generative AI operations, a system implemented using one or more large language models (LLMs), a system implemented using one or more vision language models (VLMs), a system for performing digital twin operations, a system for performing light transport simulation, a system for performing deep learning operations, a system implemented using an edge device, a system implemented using a robot, a control system for an autonomous or semi-autonomous machine, a perception system for an autonomous or semi-autonomous machine, a system incorporating one or more virtual machines (VMs), a system implemented at least partially in a data center, or a system implemented at least partially using cloud computing resources.

### BRIEF DESCRIPTION OF THE DRAWINGS

The present systems and methods for machine learning models for extracting 3D features are described in detail below with reference to the attached drawing figures, wherein:

FIG. 1 is a block diagram of an example system for extracting 3D features, in accordance with some embodiments of the present disclosure;

FIG. 2 is a block diagram of an example system for extracting 3D features, in accordance with some embodiments of the present disclosure;

FIG. 3 is a block diagram of an example system for extracting 3D features, in accordance with some embodiments of the present disclosure;

FIG. 4 is a flow diagram of an example of a method for extracting 3D features, in accordance with some embodiments of the present disclosure;

FIG. 5 is a block diagram of an example content streaming system suitable for use in implementing some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

This disclosure relates to systems and methods for extracting three-dimensional (3D) information. For example, a system can extract 3D information (e.g., bounding boxes) of one or more features of one or more objects from a source image. The system can include a first neural network to generate a first representation of the one or more objects and a second neural network to generate a second representation of the one or more objects. The first representation can include features of the one or more objects that the first neural network detects, and the second representation can include features of the one or more objects that the second neural network detects. Based at least on the first representation and the second representation, the system can output the 3D information. For example, the system can generate one or more bounding boxes for the one or more features of the one or more objects in the source image.

Feature extraction can be achieved based on data including pairs of image data and annotation data (e.g., text for describing an image of the image data). While affordable for two-dimensional features, annotating large-scale image data can be both resource-intensive and time-consuming for 3D features. Moreover, there is still a need for improving accuracy and efficiency of extracting 3D features.

Systems and methods in accordance with the present disclosure can provide solutions to extract 3D features (e.g., 3D information such as bounding boxes) more efficiently and accurately. The systems and methods disclosed herein can allow a diffusion model to generate images/features containing 3D information with the aid of a machine learning model (e.g., a neural network), which can provide the diffusion model with features that allow for a detection of 3D features in the images. For example, the diffusion model, with the aid of the machine learning model, can generate a bounding box indicating 3D information of an object within an image. In some implementations, the bounding box can indicate at least one of a depth, a shape, an orientation, etc. of the object. The diffusion model can be pre-trained and can be fine-tuned to extract the 3D features from the images. For example, the diffusion model is not required to be configured/trained from scratch, thereby reducing computational resources. This can thereby improve the efficiency of 3D feature extraction and/or generating images with 3D features while providing 3D information more accurately.

In some implementations, the systems and methods disclosed herein can utilize a machine learning model (e.g., a neural network). In one or more embodiments, the machine learning model provides features including semantic information, such that the output images can include the semantic information (e.g., a class, a category of objects within the source image) as well as the 3D information. While the diffusion model is fixed in one or more embodiments (e.g., without further training/updating), the machine learning model can be configured (e.g., trained, updated) based at least on the 3D information (e.g., bounding boxes) and/or associated annotation data to provide the features including the semantic information.

In some implementations, the systems and methods disclosed herein can utilize a machine learning model (e.g., a neural network) for view synthesis. The machine learning model can be used to generate, based on the source image, a modified image having a different pose than the source image. In some implementations, the machine learning model can be configured based at least on training images and labels associated with the training images, in order to output features analogous to the labels.

For example, systems and methods in accordance with the present disclosure can receive an input image of a first view of a scene, and can warp the input image to a second view of the scene. The system can extract 3D information regarding the scene, such as bounding boxes for objects in the scene and/or class or category information for the objects in the scene, based at least on the first view and the second view. For example, the system can include one or more neural networks and/or diffusion models that are trained to perform the warping and/or the 3D information extraction, such as based on images of scenes from different views.

The systems and methods described herein may be used for a variety of purposes, by way of example and without limitation, for synthetic data generation, machine control, machine locomotion, machine driving, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments can be implemented by or included in at least one of a system for generating synthetic data; a system for performing simulation operations; a system for performing conversational AI operations; a system for performing collaborative content creation for 3D assets; a system including one or more large language models (LLMs); a system for performing digital twin operations; a system for performing light transport simulation; a system for performing deep learning operations; a system implemented using an edge device; a system implemented using a robot; a control system for an autonomous or semi-autonomous machine; a perception system for an autonomous or semi-autonomous machine; a system incorporating one or more virtual machines (VMs); a system implemented at least partially in a data center; or a system implemented at least partially using cloud computing resources.

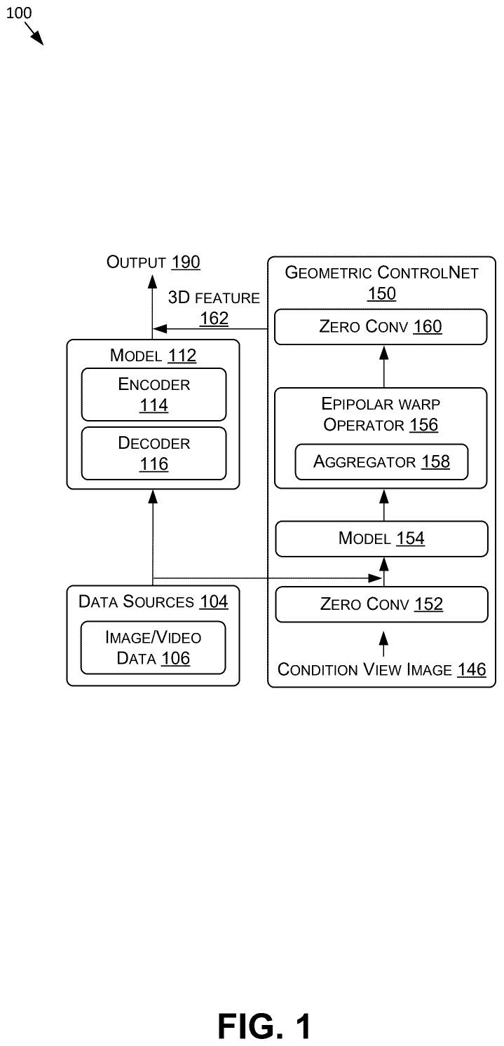

With reference to FIG. 1, FIG. 1 is an example computing environment including a system 100 for extracting 3D features, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors executing instructions stored in memory. The system 100 can include any function, model (e.g., machine learning model), operation, routine, logic, or instructions to perform functions such as configuring diffusion model 112, Geometric ControlNet 150, etc. as described herein, such as to configure machine learning models to operate as diffusion models, Geometric ControlNet 150, etc.

The system 100 can include or be coupled with one or more data sources 104. The data sources 104 can include any of various databases, data sets, or data repositories, for example. The data sources 104 can include data to be used for configuring any of various machine learning models (e.g., models 112, Geometric ControlNet 150, etc.). The one or more data sources 104 can be maintained by one or more entities, which may be entities that maintain the system 100 or may be separate from entities that maintain the system 100. In some implementations, the system 100 uses data from different data sets, such as by using data from a first data source 104 to perform at least a first configuring (e.g., updating or training) of the models 112, Geometric ControlNet 150, etc. and uses training data elements from a second data source 104 to perform at least a second configuring of the models 112, Geometric ControlNet 150, etc. For example, the first data source 104 can include publicly available data, while the second data source 104 can include domain-specific data (which may be limited in access as compared with the data of the first data source 104). The data sources 104 can include data from any suitable image dataset including labeled and/or unlabeled image data. In some implementations, the data sources 104 include data from large-scale image datasets (e.g., ImageNet) that are available from various sources and services.

The data sources 104 can include, without limitation, data 106 such as any one or more of text, speech, audio, image, and/or video data. The system 100 can perform various pre-processing operations on the data, such as filtering, normalizing, compression, decompression, upscaling or downscaling, cropping, and/or conversion to grayscale (e.g., from image and/or video data). Images (including video) of the data 106 can correspond one or more views of a scene captured by an image capture device (e.g., camera), or images generated computationally, such as simulated or virtual images or video (including by being modifications of images from an image capture device). The images can each include a plurality of pixels, such as pixels arranged in rows and columns. The images can include image data assigned to one or more pixels of the images, such as color, brightness, contrast, intensity, depth (e.g., for three-dimensional (3D) images), or various combinations thereof. The data 106 can include videos and/or video data structured as a plurality of frames (e.g., image frames, video frames), such as in a sequence of frames, where each frame is assigned a time index (e.g., time step, time point) and has image data assigned to one or more pixels of the images.

In some implementations, the image data and/or video data of the data 106 include a set of parameters, such as camera pose information. The camera pose information can indicate a point of view by which the data 106 is represented. For example, the camera pose information can indicate at least one of a position or an orientation of a camera (e.g., real or virtual camera) by which the data 106 is captured or represented.

The system 100 can train, update, or configure one or more models 112 (e.g., machine learning models). The machine learning models 112 can include machine learning models or other models that can generate target outputs based on various types of inputs. The machine learning models 112 may include one or more neural networks. The neural network can include an input layer, an output layer, and/or one or more intermediate layers, such as hidden layers, which can each have respective nodes. The system 100 can train/update the neural network by modifying or updating one or more parameters, such as weights and/or biases, of various nodes of one or more layers of the neural network responsive to evaluating candidate outputs of the neural network.

The models 112 can be or include various neural network models, including models that are effective for operating on or generating data including but not limited to image data, video data, text data, speech data, audio data, or various combinations thereof. The machine learning models 112 can include one or more transformers, recurrent neural networks (RNNs), long short-term memory (LSTM) models, other network types, or various combinations thereof. The machine learning models 112 can include generative models, such as generative adversarial networks (GANs), Markov decision processes, variational autoencoders (VAEs), Bayesian networks, autoregressive models, autoregressive encoder models (e.g., a model that includes an encoder to generate a latent representation (e.g., in an embedding space) of an input to the model (e.g., a representation of a different dimensionality than the input), and/or a decoder to generate an output representative of the input from the latent representation), or various combinations thereof.

The models 112 can include at least one diffusion model 112. The diffusion model can include a network, such as a denoising network (not shown). For example, in brief overview, the diffusion model can include a denoising network that is configured (e.g., pre-trained, trained, updated, fine-tuned, and/or has transfer learning applied) using training data of the data 106 that includes data elements to which noise is applied, and configuring the denoising network to modify the noise-augmented data elements to recover the (un-noised) data elements.

The model 112 can include (e.g., the denoising network can be implemented as) a latent diffusion model (LDM). The LDM can include or be coupled with an encoder 114. The encoder 114 can include a neural network to encode (e.g., compress) data to a lower dimensional, compressed latent space (e.g., latent tensors, latent representations, latent encoding), such as to allow operations to be performed more efficiently in the latent space. For example, this can allow the model 112 to receive high-resolution image and/or video data for configuring the model 112 while maintaining target performance levels. For example, the encoder 114 can allow the model 112 to improve the computational and memory efficiency over pixel-space Diffusion Models (DMs) by first training the encoder 114 to transform input images (e.g., of data 106) into a spatially lower-dimensional latent space of reduced complexity, from which the original data can be reconstructed at high fidelity. This approach can be implemented with a regularized autoencoder, which reconstructs input images and a decoder (e.g., a decoder neural network). The latent space can be smaller in terms of parameter count and/or memory consumption by the model 112 to operate in the latent space as compared to corresponding pixel-space DMs of similar performance.

The model 112 can include, as (part of) the LDM, the denoising network (not shown), which can be coupled with the encoder 114, such as to perform operations on data mapped to the latent space by the encoder 114. The system 100 can configure the denoising network by causing the denoising network to reproduce example data to which noise has been applied. In some implementations, the system 100 configures the denoising network by conditioning the denoising network according to conditioning inputs (e.g., text inputs), allowing the denoising network to generate outputs responsive to receiving inputs (e.g., at runtime/inference time).

For example, the system 100 can perform diffusion on one or more images x₀ (and/or image frames of video) of the data 106. The system 100 can perform diffusion by applying noise to (e.g., diffusing) the data 106, to determine training data points (e.g., diffused or noised data, such as noised images x_{T}). For example, the system 100 can add the noise to the data 106 (e.g., add a numerical value representing the noise in a same data format as the data 106, to the data 106) to determine the training data points. The system 100 can determine the noise to add to the data 106 using one or more noise distributions, which may indicate a noise level according to a time t, where 0<t<T, such that applying noise corresponding to the time T may result in the training data point x_{T} representing Gaussian noise. For example, the noise can be a sample of a distribution, such as a Gaussian distribution. The system 100 can apply the noise according to or with respect to a duration of time t. The duration of time t can be a value in a time interval, such as a value between zero and a maximum T of the time interval. The duration of time t may be a multiple of a number of discrete time steps between zero and T. The maximum T may correspond to an amount of time such that the result of applying noise for a duration of time T may be indistinguishable or almost indistinguishable from Gaussian noise. For example, the system 100 can apply diffusion to the image x₀ for the duration T to determine the training data point (e.g., noised image) x_{T}.

The denoising network discussed above can be implemented, for example and without limitation, using a U-Net, such as a convolutional neural network that includes downscaling and upscaling paths. The denoising network can receive the training data point x_{T} and determine an estimated output responsive to receiving the training data point x_{T}. The estimated output can have a same format as the training data point x_{T}, such as to be an image having a same number of rows of pixels and columns of pixels as the training data point x_{T} (and/or as data 106 compressed by the encoder 114, such as where the denoising network generates the estimated output and provides the estimated output to a decoder 116 for decoding up to the format of the data 106).

In some implementations, the system 100 can cause the model 112 (e.g., LDM as implemented by the denoising network) to learn to model the data distribution x via iterative denoising using the denoising network, and can be trained (e.g., updated) with denoising score matching. A noise schedule can be parameterized via a diffusion time over which logarithmic signal-to-noise ratio monotonically decreases. A denoiser model can receive the diffused inputs that are parameterized with learnable parameters and can optimize a denoising score matching objective based on conditioning information (e.g., text prompt), target vector (e.g., random noise), forward diffusion process, reverse generation process, and so on. The input images x can be perturbed into a Gaussian random noise over a maximum diffusion time (e.g., time T). An iterative generative denoising process that employs the learned denoiser (e.g., the denoising neural network) can be initialized from the Gaussian noise to synthesize novel data.

Referring further to FIG. 1, the system 100 can configure the model 112 to be or include a video diffusion model, such as a video LDM. For example, the system 100 can configure the model 112 (e.g., the denoising network) to include or be coupled with at least one temporal layer. This can allow the denoising network (e.g., together with temporal layer(s)) to generate outputs having image data (e.g., in two or three spatial dimensions) over time (e.g., based on operation of the at least one temporal layer). The temporal layer can be, for example, one or more neural network layers, such as an attention neural network layer.

The system 100 can configure the temporal layer using video data of the data 106, such as one or more sequence of frames of video retrieved from the data 106. For example, the system 100 can update/train the temporal layer (e.g., independently from or together with the denoising network) to align multiple images generated by the denoising network into frames of a video, by, for example, aligning multiple images generated by the denoising network into consecutive frames of the video, referred to as the first video. The first video can be an initial low-temporal-resolution (or low frame rate, low FPS) video and low-spatial-resolution video (referred to as the first video) that is up-sampled in the manner described herein.

The system 100 can train or update the at least one temporal layer by modifying or updating one or more parameters, such as weights and/or biases, of various nodes of the neural network responsive to evaluating candidate outputs of the at least one temporal layer. The output of the at least one temporal layer can be used to evaluate whether the at least one temporal layer has been trained/updated sufficiently to satisfy a target performance metric, such as a metric indicative of accuracy of the at least one temporal layer in generating outputs. Such evaluation can be performed based on various types of loss. For example, the system 100 can use a function such as a loss function to evaluate a condition for determining whether the at least one temporal layer is configured (sufficiently) to meet the target performance metric. The condition can be a convergence condition, such as a condition that is satisfied responsive to factors such as an output of the function meeting the target performance metric or threshold, a number of training iterations, training of the at least one temporal attention neural network layer converging, or various combinations thereof.

As discussed, the encoder 114 can map an input image (e.g., the image data 106) from an image or pixel space to a lower dimensional, compressed latent space (e.g., latent tensors, latent representations, latent encoding, and so on) where the denoising network can be updated or trained more efficiently in terms of power consumption, memory consumption, and/or time. The decoder 116 can map the latent encoding back to the image space. The model 112 (e.g., video LDM including the denoising network and temporal layers), fine-tuned from the image diffusion model, can model/generate/develop an increased number of video frames at the same time given fixed memory budget as compared to operating in image or pixel space directly, thus facilitating long-term video generation.

In some implementations, the temporal layer can be updated or trained using the data 106 (e.g., video) in the manner described herein. In some implementations, the model 112 is fine-tuned or updated using the data 106 to allow the model 112 to avoid introducing temporal incoherencies when decoding a frame sequence (e.g., multiple latent tensors, latent representations, latent encoding, and so on corresponding to multiple input images) generated from the latent space. The data 106 can include image data and video data in the same domain. In some implementations. In some implementations, the image data and the video data of the data 106 can be in different domains, or have a domain gap.

For example, the model 112 (e.g., video LDM) can include one or more layers configured to process image data and/or spatial data, and one or more temporal layers configured for the time dimension, such as by fine-tuning a neural network that includes the denoising network (having been updated/trained on image data) and the one or more temporal layers as included with the denoising network. The system 100 can include an optimizer to configure the model 112, such as to update one or more parameters (e.g., weights, biases) of the model 112 based at least on a gradient generated for the model 112.

As depicted in FIG. 1, the models 112 can receive an input, and can generate output(s) 190 responsive to the input. The input can include any one or more text, speech, audio, image, and/or video input data, based at least on which the models can generate the outputs 190, such as to generate 2D image, 3D image, and/or video outputs. For example, the input can represent text information such as “a dog running,” responsive to which the text-to-image model can generate an image frame of a dog running, the multiview diffusion model 112 can generate multiple image frames from multiple camera views of a dog running, and the text-to-video model 112 can generate a sequence of image frames representative of a dog running (e.g., showing motion of the dog across the sequence of frames). In some implementations, the models 112 can receive the data 106 as an input and generate the output 190 responsive to the data 106.

Referring to FIG. 1, a Geometric ControlNet 150 can be used to extract 3D information. For example, the Geometric ControlNet 150 can extract 3D information of one or more features of an object within the data 106 (e.g., an image) and configure the output 190 to include the 3D information (e.g., bounding boxes). The Geometric ControlNet 150 can include zero convolutions 152, 160, an Epipolar warp Operator 156 that includes an aggregator 158, and a model 154. In a brief overview, the model 112 can receive the data 106 (e.g., a two-dimensional image including one or more objects) as a source image. As discussed above, the model 112 can be a pre-trained diffusion model configured to generate a first representation of the one or more objects in the source image. The first representation can include one or more features of the one or more objects, such as characteristics of objects that the model 112 has been trained to detect (e.g., and without limitation, size, color, shape, orientation). The first representation can include image data or an image-like data structure that represents the one or more features.

The Geometric ControlNet 150 can receive the data 106 and a condition view image 146, and generate a second representation (e.g., a 3D feature 162, including, for example, shape, depth, orientation, or bounding information) of the one or more objects, based at least in part on the data 106 and the condition view image 146. The second representation can include an image or image-like data structure that includes the second representation.

The system 100 can generate the output 190 based on the first representation and the second representation of the one or more objects. For example, the output 190 can include the 3D feature 162. In some implementations, the 3D feature 162 can include one or more bounding boxes of the one or more objects. In some implementations, each of the one or more bounding boxes can include or indicate at least one of a depth, a shape, or an orientation of the one or more objects.

In some implementations, the model 154 can be a trainable copy of the model 112. The Geometric ControlNet 150 can copy the model 112, denoted as Fₛ(·; Θₛ), and can be denoted as Fₛ′(·; Θ′ₛ), while accompanying with the zero convolutions 152, 160 Zₛ₁ and Zₛ₂, parameterized by Θzs1 and Θzs2, respectively. With the notation of x∈_{R}H×W×C as the arbitrary middle features of xt in F, the Geometric ControlNet 150 with the model 112 can be indicated as:

$${y}_{s} = {F}_{s} ( x ; {Θ}_{s} ) + {Z}_{s 2} ( {F}_{{s}^{′}} ( x + {Z}_{s 1} ( c ; Θ zs 1 ) ; {Θ}^{′} s ) ; Θ zs 2 ) ,$$

where the condition view image 146 can be indicated as c∈RH×W×C, and the output 190 can be indicated as yₛ∈_{R}H×W×C.

In some implementations, the model 154 can be configured based at least on an input training image, a target training image (e.g., condition view image 146), and an indication of a pose of the target training image relative to an indication of the input training image. In some implementations, the model 154 can be trained using the data 106 (e.g., data used as a source image for an input training image), the condition view image 146 (e.g., a target training image, conditioned based on the source image), etc. In some implementations, the condition view image 146 can be an image that captures the same scene as the source image but in a different pose, and an indication of a pose of the target training image relative to an indication of the input training image can be used to train the model 154. For example, a plurality of source images, a plurality of target images at different poses, and information indicating the differences in poses between the source images and the corresponding target images to be used for conditioning can be used to train the model 154. This allows for the system 100 to train the model 154 with keeping the model 112 that is pre-trained “frozen” (e.g., fixed without further training).

The epipolar warp operator 156 can apply an epipolar geometric warping to one or more features of the source image from the data sources 104 that depicts a scene using a first set of camera parameters, based on the condition view image 146 associated with the source image, to determine a second set of camera parameters. The camera parameters can include a pose, direction, field of view, and/or focal length. The camera parameters can include intrinsic and/or extrinsic camera parameters. In some implementations, the epipolar warp operator 156 can apply the epipolar geometric warping by sampling the one or more features along an epipolar line corresponding to the source image and the condition view image, and then aggregating the one or more features at corresponding positions in the synthetic image. In some implementations, when the epipolar warp operator 156 applies the epipolar geometric warping to one or more features of the source image, the source image (and/or the representation of the one or more features associated with the first camera) and/or the condition view image (and/or the representation of the one or more features associated with the second camera) may be unmodified by the epipolar geometry warping, such as to not be changed responsive to the execution of the epipolar geometry warping. In some implementations, the epipolar warp operator 156 can aggregate the one or more features using a differentiable aggregator.

In some implementations, based on the epipolar geometric warping, the epipolar warp operator 156 can output the 3D feature 162 based on alignment between the source image and the target image (e.g., conditioned based on the source image). In response to receiving this pair of images, the epipolar warp operator 156 can align the pair based at least on an indication of a pose of the target image relative to an indication of the source image. In some implementations, the epipolar warp operator 156 can warp the source image to align with the target image. With denoting the epipolar warp operator 156 as G(·, Tₙ), Geometric ControlNet 150 can be formulated as:

$${y}_{s} = {F}_{s} ( x ; {Θ}_{S} ) + {Z}_{s 2} ( G ( {F}_{{s}^{′}} ( x + {Z}_{s 1} ( c ; {Θ}_{zs 1} ) ; {Θ}_{s}^{′} ) , {T}_{n} ) ; {Θ}_{zs 2} ) .$$

To obtain the target image at a position (u, v), the extrinsic relative pose relative to the source image can be described as Tₙ=[[Rₙ,0]^{T}, [tₙ, 1]^{T}], and the intrinsic parameters can be represented as K. With the notation above, the epipolar warp operator 156 can generate an epipolar line, l_{c}, for the pair of the source image and the target image:

$${1}_{c} = {K}^{- T} ( [ {t}_{n} ] \times {R}_{n} ) {{K}^{- 1} [ u , v , 1 ]}^{T} ,$$

where, l_{c} denotes the epipolar line associated with the source conditional image. To align the pair of images, the epipolar warp operator 156 can sample a set of features, denoted as {c(pᵢ)}, along the epipolar line, where pᵢ can be points on the epipolar line. In some implementations, the aggregator 158 can aggregate the set of features at the target view position (u, v) via a differentiable aggregator function. In some implementations, the differentiable aggregator function can be or include an averaging function, a maximizing function, a transformer, etc. The epipolar warp operator 156 can generate a warped condition image feature, c′, as an output:

$${c}^{′} ( u , v ) = aggregator ( \{ c ( pi ) \} ) , {p}_{i} \sim {l}_{c} .$$

The Geometric ControlNet 150 can output the 3D feature 162 based on the output, c′, through the zero convolution 160. As discussed above, the output 190 can include the 3D feature 162 therein. In some implementations, the output 190 can include bounding boxes indicating 3D information of one or more objects within an output image. In some implementations, the model 112 can generate, using a neural network, a synthetic image representing the one or more features and corresponding to the second set of camera parameters (e.g., the second set of camera parameters determined based on the epipolar geometric warping). In some implementations, the neural network may be or include a stable diffusion model. In some implementations, the neural network can be updated using image pairs, at least one image pair depicting at least one feature of one or more objects in common and including data indicating a relative pose or position of a camera capturing each image of the at least one image pair. For example, the neural network can be updated using image pairs (e.g., the source image and the condition view image 146) whose relative camera pose or position is obtained from the epipolar geometric warping.

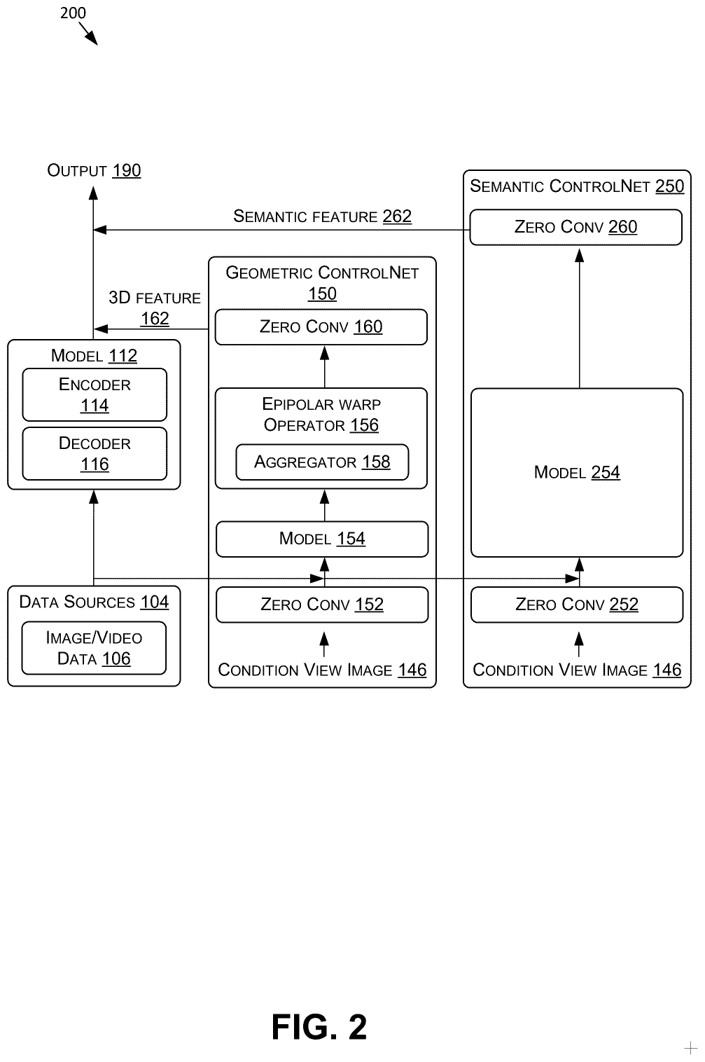

With reference to FIG. 2, FIG. 2 is an example computing environment including a system 200 for extracting 3D features, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors executing instructions stored in memory. The system 200 can include any function, model (e.g., machine learning model), operation, routine, logic, or instructions to perform functions such as configuring model 254, a Semantic ControlNet 250, etc. as described herein, such as to configure machine learning models to operate as model 254, the Semantic ControlNet 250, etc. In some implementations, the system 200 can be substantially similar to or incorporate features of the system 100. As shown, the system 200 can include the system 100 and additionally, Semantic ControlNet 250.

Referring to FIG. 2, the Semantic ControlNet 250 can be used to extract semantic information. For example, the Semantic ControlNet 250 can extract semantic information of one or more features of an object within the data 106 (e.g., an image) and configure the output 190 to include the semantic information. The Semantic ControlNet 250 can include zero convolutions 252, 260, and a model 254. In a brief overview, the model 112 can receive the data 106 (e.g., a two-dimensional image including one or more objects) as a source image. As discussed above, the model 112 can be a pre-trained diffusion model configured to generate a first representation of the one or more objects in the source image. Here, The Geometric ControlNet 150 can be “frozen” (e.g., fixed without further training). The Geometric ControlNet 150 can receive the data 106 and the condition view image 146, and generate a second representation (e.g., the 3D feature 162) of the one or more objects, based at least in part on the data 106 and the condition view image 146. The semantic ControlNet 250 can receive the data 106 and the condition view image 146, and generate a third representation (e.g., the semantic feature 262) of the one or more objects, based at least in part on the data 106 and the condition view image 146. The output 190 can be generated based on the first representation, the second representation (e.g., the 3D feature 162), and the third representation (e.g., the semantic feature 262) of the one or more objects. For example, the output 190 can include the 3D feature 162 and the semantic feature 262. In some implementations, the semantic feature 262 can include semantic information of the one or more objects in the source image. For example, the semantic information can include a class, a category, etc. of the one or more objects in the source image.

In some implementations, the Semantic ControlNet 250 can be used to further optimize the output 190 by providing the semantic feature 262. The semantic feature 262, with the 3D feature 162, allows the one or more features of the one or more objects in the source image to be fine-turned. The Semantic ControlNet 250 can compute a first set of two-dimensional (2D) bounding boxes corresponding to at least one feature of the one or more features of the source image, compute a second set of 2D bounding boxes corresponding to the at least one feature in the synthetic image, and compute a set of three-dimensional (3D) bounding boxes corresponding to the at least one feature using the first and second sets of 2D bounding boxes. In some implementations, the Semantic ControlNet 250 can automatically assign a label corresponding to at least one 2D bounding box corresponding to at least one feature in the source image to at least one 3D bounding box corresponding to at least one feature. For example, the Semantic ControlNet 250 can assign the label including semantic information obtained based on the 2D bounding box to the 3D bounding box, thereby outputting 3D information associated with the feature corresponding to the 3D bounding box.

In some implementations, the Semantic ControlNet 250 can be used to output the semantic feature 262 while the model 112 and the Geometric ControlNet 150 (e.g., the model 154) is “frozen” (e.g., fixed without further training). In an example, where an input image x (e.g., the data 106) is provided, the features extracted (e.g., through a single denoising forward step in the model 112) from the input image using the model 112 can be denoted as F(x). The input image x can be fed into the Geometric ControlNet 150, and the features extracted therefrom can be represented as F_{geo}(x,Tₙ), with an identity pose (Tₙ=[Id,0]) to obtain the 3D feature 162. Here, the Semantic ControlNet 250, represented as Fₛₑₘ(x), can be introduced to produce trainable features that can be fine-tuned for detection within the target data distribution. The Semantic ControlNet 250 can thereby include the semantic feature 262 in the output 190 or allow the output 190 to be configured based on the semantic feature 262. Here, the output 190 can be represented as:

$$y = V ( F ( x ) {+}_{Fgeo ( x ,} [ I d , 0 ] ) + Fsem ( x ) ) ,$$

where V represents the model 254.

In some implementations, features (e.g., the features from the model 112, the 3D feature 162, etc.) can be aggregated into the model 254 and can be used to train the Semantic ControlNet 250 (e.g., the model 254). In some implementations, the Semantic ControlNet 250 can be configured based at least on a training image and a label associated with the training image. For example, the model 254 can be trained with label-supervision, based on a plurality of training images and a plurality of corresponding labels.

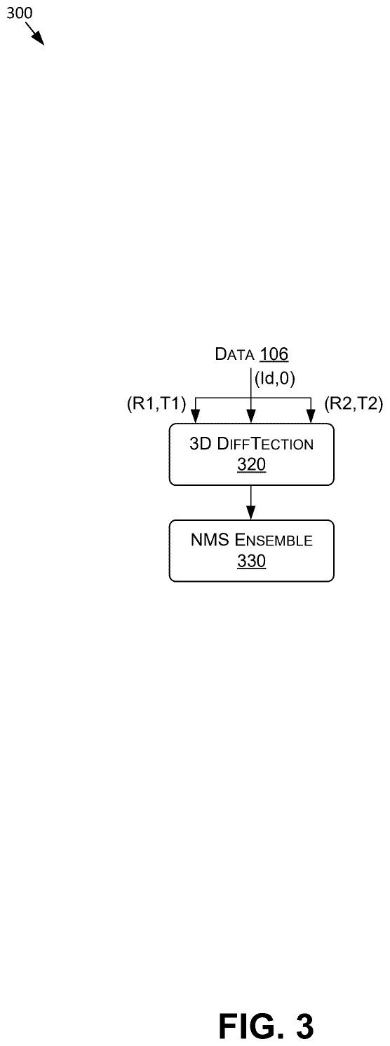

With reference to FIG. 3, FIG. 3 is an example computing environment including a system 300 for extracting 3D features, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors executing instructions stored in memory. The system 300 can include any function, model (e.g., machine learning model), operation, routine, logic, or instructions to perform functions such as configuring NMS (Non-Maximum Suppression) ensemble 330, etc. as described herein. In some implementations, the system 300 can be substantially similar to or incorporate features of the system 100 and/or the system 200. For example, a model for performing three dimensional object detection with geometry aware diffusion features (“3D DiffTection”) 320 can be any of the system 100, the system 200, or any model therein, and the system 300 can additionally include NMS Ensemble 330.

Referring to FIG. 3, the system 300 can be used to perform view synthesis. In some implementations, the system 300 can provide a modified view, while 3D DiffTection 320 is “frozen” (e.g., fixed without further training). In some implementations, NMS Ensemble 330 can combine outputs from 3D DiffTection 320 (e.g., outputs from the Geometric ControlNet 150, the Semantic ControlNet 250, etc.) to generate an inference and/or prediction and perform view synthesis based thereon. In some implementations, the system 300 can receive the data 106 as a source image, and can generate a modified image (e.g., an inferred view, etc.) based on the source image. Here, the modified image can have a different pose than the source image. In some implementations, the system 300 can input the modified image to the Geometric ControlNet 150 (e.g., the model 154) in 3D DffTection 320. The Geometric ControlNet 150 can then generate a fourth representation of the one or more 3D objects. This allows the system 300 to generate features from the modified view. For example, the Geometric ControlNet 150 can generate bounding boxes for one or more objects in the modified view. In some implementations, the system 300 can incorporate the features from the modified view in the output 190. For example, the output 190 can be generated based on the features from the model 112, the 3D feature 162, the semantic feature 262, and the features from the modified view. In some implementations, the modified view can include a novel view of one or more features (or portions of one or more features) that is not depicted in the source image.

With viewing transformations denoted as &i, the output incorporated in the system 300 can be represented as:

$$y ( ξ ) = V ( F ( x ) + {F}_{geo} ( x , ξ ) + {F}_{sem} ( x ) ) .$$

With an NMS ensemble, the output of the system 300 can be represented as:

y_{final}=NMS({y({ξi}).

In some implementations, the system 300 can include a plurality of neural networks. For example, the system 300 can include a first neural network (e.g., the neural network of the system 100) and a second neural network. In some implementations, the system 300 can provide the source image (e.g., from the data sources 104), the synthetic image (e.g., as in the output 190), the first set of camera parameters (e.g., associated with the source image), and the second set of camera parameters (e.g., associated with the condition view image 146) to a second neural network. Although discussed with respect to the system 100, the first neural network may be of the system 200, in some implementations. The system 300 can update one or more parameters of the second neural network based at least on one or more of the received source image, synthetic image, first set of camera parameters, and/or second set of camera parameters. Based on the updated second neural network, the system 300 can compute one or more 3D bounding boxes corresponding to one or more features of one or more input images using the second neural network. In some implementations, the system 300 can provide 2D bounding boxes and 3D bounding boxes corresponding to one or more features of the source image and one or more corresponding features of the synthetic image to update the one or more parameters of the second neural network.

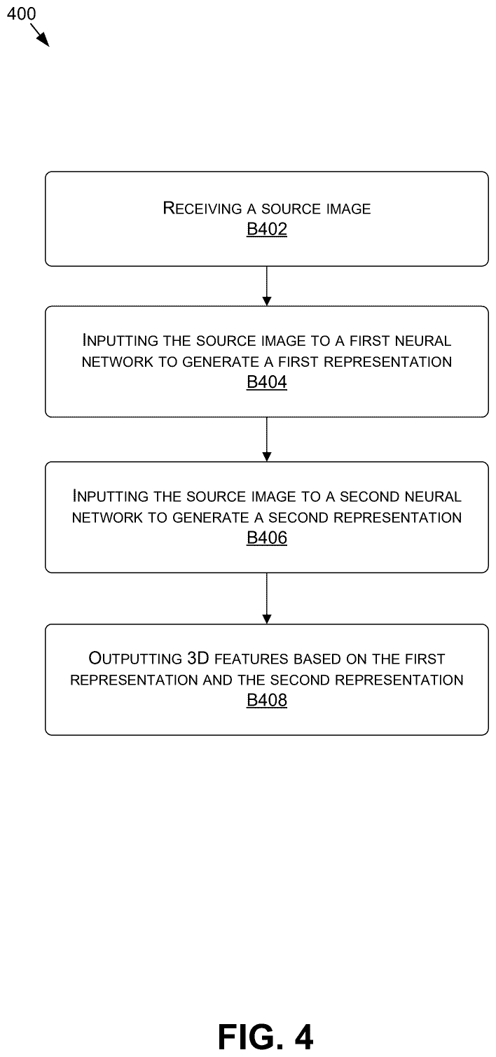

FIG. 4 is a flow diagram showing a method 400 for extracting 3D features, in accordance with some embodiments of the present disclosure. Various operations of the method 400 can be implemented by the same or different devices or entities at various points in time. For example, one or more first devices may implement operations relating to configuring diffusion machine learning models, one or more second devices may implement operations relating to a second and/or third machine learning model, and one or more third devices may implement operations relating to receive user inputs requesting content to be generated by the diffusion machine learning models and/or the second and/or third machine learning model and presenting or otherwise providing the content. The one or more third devices may maintain the neural network models, or may access the neural network models using, for example and without limitation, APIs provided by the one or more first devices and/or the one or more second devices.

The method 400, at block B402, includes receiving a source image. From the source image, one or more 3D features of one or more objects in the source image can be detected. In some implementations, the source image can be or include a 2D image. The source image can include any one or more of image or video data (e.g., a video frame, etc.).

The method 400, at block B404, can include inputting the source image to a first neural network to generate a first representation. In some implementations, the first neural network is a pre-trained diffusion model configured to receive the source image and generate the first representation (e.g., features) based on the source image.

The method 400, at block B406, can include inputting the source image to a second neural network to generate a second representation. In some implementations, the second neural network can be configured (e.g., one or more parameters may be trained or updated) based at least on an input training image, a target training image, and an indication of a pose of the target training image relative to an indication of the input training image. For example, the second neural network can be trained based at least on an input training image, a target training image, and an indication of a pose of the target training image relative to an indication of the input training image. In some implementations, the second neural network can be a trainable instantiation of the first neural network.

In some implementations, the first neural network and the second neural network can provide their respective outputs to a third neural network. In some implementations, the third neural network can generate a third representation of the one or more objects based on the source image and the outputs from the first and the second neural networks. In some implementations, the third representation can be or include semantic information of the one or more objects. For example, the semantic information can include a class, a category, etc. of the one or more objects.

The method 400, at block B408, includes outputting 3D features based on the first representation and the second representation. In some implementations, the 3D features can include one or more bounding boxes of the one or more objects. In some implementations, each of the bounding boxes can indicate at least one of a depth, a shape, or an orientation of the one or more objects.

### Example Content Streaming System

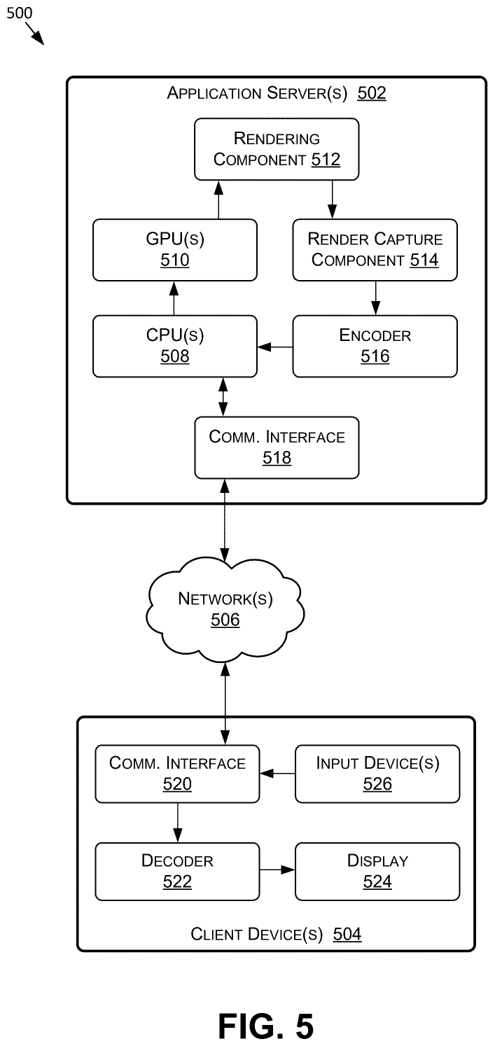

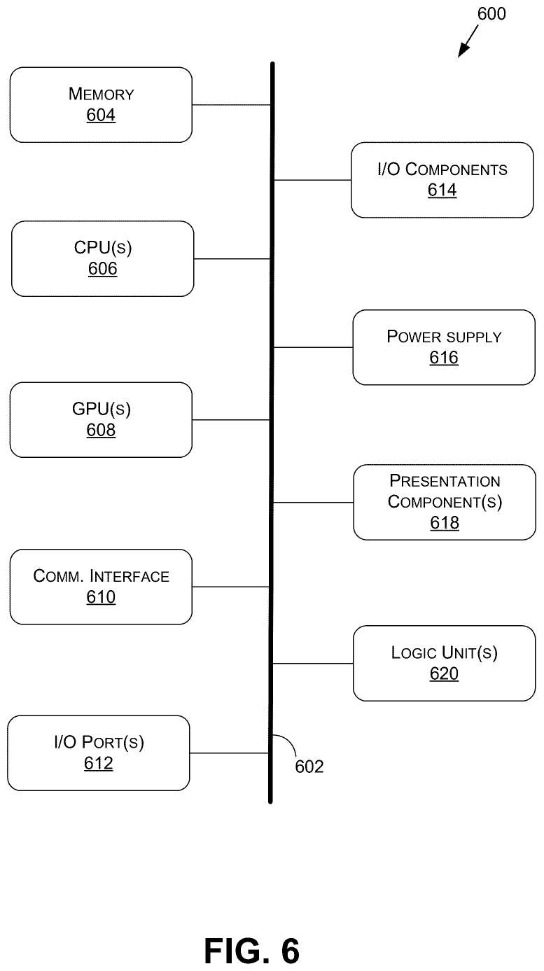

Now referring to FIG. 5, is an example system diagram for a content streaming system 500, in accordance with some embodiments of the present disclosure. FIG. 5 includes application server(s) 502 (which may include similar components, features, and/or functionality to the example computing device 600 of FIG. 6), client device(s) 504 (which may include similar components, features, and/or functionality to the example computing device 600 of FIG. 6), and network(s) 506 (which may be similar to the network(s) described herein). In some embodiments of the present disclosure, the system 500 may be implemented to train/update and/or execute machine-learning models to transform input images to target viewpoints, as described herein. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 500 can be implemented to receive input indicating one or more features of output to be generated using a neural network model, provide the input to the model to cause the model to generate the output, and use the output for various operations including display or simulation operations.

In the system 500, for an application session, the client device(s) 504 may only receive input data in response to inputs to the input device(s) 526, transmit the input data to the application server(s) 502, receive encoded display data from the application server(s) 502, and display the display data on the display 524. As such, the more computationally intense computing and processing is offloaded to the application server(s) 502 (e.g., rendering—in particular ray or path tracing—for graphical output of the application session is executed by the GPU(s) of the application server(s) 502). In other words, the application session is streamed to the client device(s) 504 from the application server(s) 502, thereby reducing the requirements of the client device(s) 504 for graphics processing and rendering.

For example, with respect to an instantiation of an application session, a client device 504 may be displaying a frame of the application session on the display 524 based at least on receiving the display data from the application server(s) 502. The client device 504 may receive an input to one of the input device(s) 526 and generate input data in response. The client device 504 may transmit the input data to the application server(s) 502 via the communication interface 520 and over the network(s) 506 (e.g., the Internet), and the application server(s) 502 may receive the input data via the communication interface 518. The CPU(s) 508 may receive the input data, process the input data, and transmit data to the GPU(s) 510 that causes the GPU(s) 510 to generate a rendering of the application session. For example, the input data may be representative of a movement of a character of the user in a game session of a game application, firing a weapon, reloading, passing a ball, turning on a vehicle, etc. The rendering component 512 may render the application session (e.g., representative of the result of the input data) and the render capture component 514 may capture the rendering of the application session as display data (e.g., as image data capturing the rendered frame of the application session). The rendering of the application session may include ray or path-traced lighting and/or shadow effects, computed using one or more parallel processing units-such as GPUs, which may further employ the use of one or more dedicated hardware accelerators or processing cores to perform ray or path-tracing techniques—of the application server(s) 502. In some embodiments, one or more virtual machines (VMs)—e.g., including one or more virtual components, such as vGPUs, vCPUs, etc.—may be used by the application server(s) 502 to support the application sessions. The encoder 516 may then encode the display data to generate encoded display data and the encoded display data may be transmitted to the client device 504 over the network(s) 506 via the communication interface 518. The client device 504 may receive the encoded display data via the communication interface 520 and the decoder 522 may decode the encoded display data to generate the display data. The client device 504 may then display the display data via the display 524.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may be arranged in various topologies, including but not limited to bus, star, ring, mesh, tree, or hybrid topologies. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU 608 may include its own memory or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, including wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608. In some embodiments, a plurality of computing devices 600 or components thereof, which may be similar or different to one another in various respects, can be communicatively coupled to transmit and receive data for performing various operations described herein, such as to facilitate latency reduction.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some implementations, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

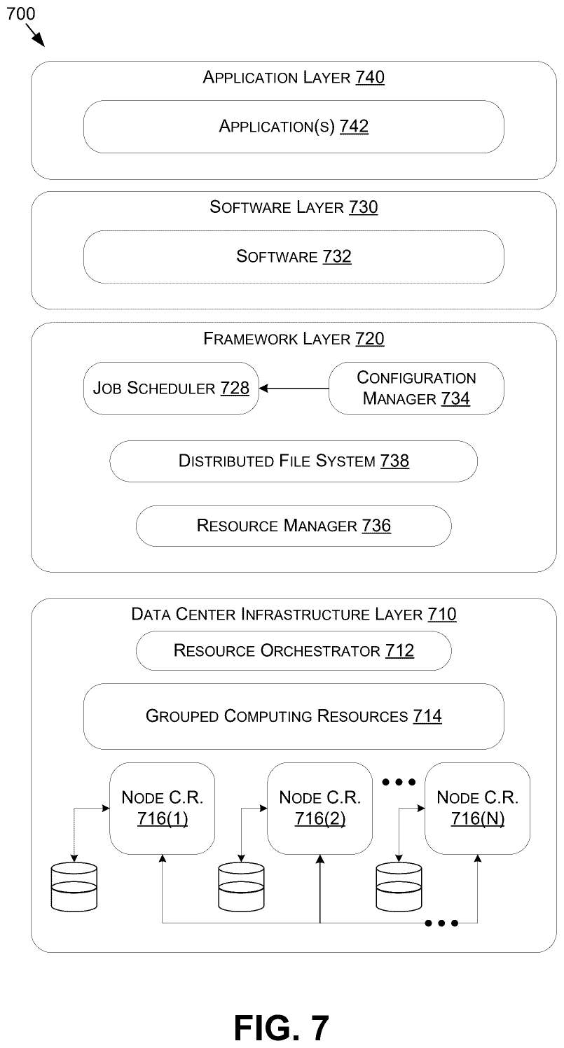

FIG. 7 illustrates an example data center 700 that may be used in at least one embodiments of the present disclosure, such as to implement the systems 100, 200, or in one or more examples of the data center 700. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine-learning application, including training or inferencing software, machine-learning framework software (e.g., PyTorch, TensorFlow, Caffe, etc.), and/or other machine-learning applications used in conjunction with one or more embodiments, such as to train/update and/or execute machine-learning models (e.g., the first machine-learning model 112) to transform input images (e.g., one or more images of a set of sequential images in the data sources 104) to target viewpoints.

In at least one embodiment, any of configuration manager 734, resource manager 736, and resource orchestrator 712 may implement any number and type of self-modifying actions based at least on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to update/train one or more machine-learning models (e.g., the system 300, etc.) or predict or infer information using one or more machine-learning models according to one or more embodiments described herein. For example, a machine-learning model(s) may be updated/trained by calculating weight parameters according to a neural network architecture using software and/or computing resources described above with respect to the data center 700. In at least one embodiment, trained or deployed machine-learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to update/train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
apply, to one or more features of a source image that depicts a scene using a first set of camera parameters, based on a condition view image associated with the source image, an epipolar geometric warping to determine a second set of camera parameters; and
generate, using a neural network, a synthetic image representing the one or more features and corresponding to the second set of camera parameters.

2. The one or more processors of claim 1 wherein the neural network is updated using image pairs, at least one image pair depicting at least one feature of one or more objects in common and including data indicating a relative pose or position of a camera capturing each image of the at least one image pair.

3. The one or more processors of claim 1, wherein to apply the epipolar geometric warping, the one or more circuits are further to:
sample the one or more features along an epipolar line corresponding to the source image and the condition view image; and
aggregate the one or more features at corresponding positions in the synthetic image.

4. The one or more processors of claim 3, wherein the one or more circuits are further to aggregate the one or more features using a differentiable aggregator.

5. The one or more processors of claim 1, wherein the neural network comprises a stable diffusion model.

6. The one or more processors of claim 1, wherein representations of the one or more features in at least one layer of the neural network are unmodified by the epipolar geometry warping.

7. The one or more processors of claim 1, wherein the one or more circuits are further to:
compute a first set of two-dimensional (2D) bounding boxes corresponding to at least one feature of the one or more features of the source image;
compute a second set of 2D bounding boxes corresponding to the at least one feature in the synthetic image; and
compute a set of three-dimensional (3D) bounding boxes corresponding to the at least one feature using the first and second sets of 2D bounding boxes.

8. The one or more processors of claim 7, wherein the one or more circuits are further to:
automatically assign a label corresponding to at least one 2D bounding box corresponding to the at least one feature of the one or more features of the source image to at least one 3D bounding box corresponding to the at least one feature.

9. The one or more processors of claim 1, wherein the one or more circuits are further to:
provide the source image, the synthetic image, the first set of camera parameters, and the second set of camera parameters to a second neural network;
update one or more parameters of the second neural network based at least on one or more of the source image, the synthetic image, the first set of camera parameters, or the second set of camera parameters; and
compute one or more 3D bounding boxes corresponding to one or more features of one or more input images using the second neural network.

10. The one or more processors of claim 9, further wherein the one or more circuits are further to provide 2D bounding boxes and 3D bounding boxes corresponding to one or more features of the source image and one or more corresponding features of the synthetic image to update the one or more parameters of the second neural network.

11. The one or more processors of claim 1, wherein the one or more processors are comprised in at least one of:
a system for generating synthetic data;
a system for performing simulation operations;
a system for performing conversational AI operations;
a system for performing collaborative content creation for 3D assets;
a system performing generative AI operations;
a system implemented using one or more large language models (LLMs);
a system implemented using one or more vision language models (VLMs);
a system for performing digital twin operations;
a system for performing light transport simulation;
a system for performing deep learning operations;
a system implemented using an edge device;
a system implemented using a robot;
a control system for an autonomous or semi-autonomous machine;
a perception system for an autonomous or semi-autonomous machine;
a system incorporating one or more virtual machines (VMs);
a system implemented at least partially in a data center; or
a system implemented at least partially using cloud computing resources.

12. A system, comprising:
one or more processing units; and
one or more memory units storing instructions that, when executed by the one or more processing units, cause the one or more processing units to execute operations comprising:
applying, to one or more features of a source image that depicts a scene using a first set of camera parameters, based on a condition view image associated with the source image, an epipolar geometric warping to determine a second set of camera parameters; and
generating, using a neural network, a synthetic image representing the one or more features and corresponding to the second set of camera parameters.

13. The system of claim 12, wherein the neural network is updated using image pairs, at least one image pair depicting at least one feature of one or more objects in common and including data indicating a relative pose or position of a camera capturing each image of the at least one image pair.

14. The system of claim 13, wherein to apply the epipolar geometric warping, the one or more processing units are further to:
sample the one or more features along an epipolar line corresponding to the source image and the condition view image; and
aggregate the one or more features at corresponding positions in the synthetic image.

15. The system of claim 14, wherein the one or more circuits are further to aggregate the one or more features using a differentiable aggregator.

16. The system of claim 12, wherein the neural network comprises a stable diffusion model.

17. The system of claim 12, wherein representations of the one or more features in at least one layer of the neural network are unmodified by the epipolar geometry warping.

18. The system of claim 12, wherein the one or more processing units are further to:
compute a first set of two-dimensional (2D) bounding boxes corresponding to at least one feature of the one or more features of the source image;
compute a second set of 2D bounding boxes corresponding to the at least one feature in the synthetic image; and
compute a set of three-dimensional (3D) bounding boxes corresponding to the at least one feature using the first and second sets of 2D bounding boxes.

19. A method comprising:
applying, by one or more processors, to one or more features of a source image that depicts a scene using a first set of camera parameters, based on a condition view image associated with the source image, a warping operation to determine a second set of camera parameters; and
generating, by the one or more processors, using a neural network, a synthetic image representing the one or more features and corresponding to the second set of camera parameters.

20. The method of claim 19, wherein the applying of warping operation includes:
sampling the one or more features along an epipolar line between the source image and the condition view image; and
aggregating the one or more features at corresponding positions in the synthetic image.
